(19) United States
(12) Patent Application Publication
(10) Pub. No.: US 2010/0148858 A1
(43) Pub. Date: Jun. 17, 2010

(54) BIAS CIRCUIT

(75) Inventor: Masatoshi SUZUKI, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/610,783

(22) Filed: Nov. 2, 2009

(30) Foreign Application Priority Data
Nov. 4, 2008 (JP) 2008-283177

(51) Int. Cl. G05F 1/10

(52) U.S. Cl. 327/543

(57) ABSTRACT

A bias circuit is provided in a circuit including an input line and an output line, and is formed on a substrate that supplies dc power to an active component. The input line reaches an input terminal of the active component from a signal line input terminal to which a signal is inputted, and the output line reaches, from an output terminal of the active component, a signal line output terminal that outputs a signal therefrom. This bias circuit includes: a power supply line supplied with the dc power; a bridge-like metal structure subjected to a bending process, which connects the output line and the power supply line to each other; and a capacitive component provided between a ground and a node between the power supply line and the metal structure.

### CROSS REFERENCE TO RELATED APPLICATION

This application is based upon and claims the benefit of priority from prior Japanese Patent Application P2008-283177 filed on Nov. 4, 2008.

### BACKGROUND OF THE INVENTION

1. Field of the Invention

The present invention relates to a bias circuit for supplying dc power to an active component that configures an amplifier circuit.

2. Description of the Related Art

Japanese Examined Patent Publication No. H02-49041 (published in 1990) discloses, as the related art, a dc bias circuit for a semiconductor device. Here, the dc bias circuit is provided in a matching circuit for the semiconductor device, and the matching circuit uses a microstrip line for use in a super high frequency band. For a thin conductor line for realizing a high characteristic impedance (or high reactance) line of 100 [Ω] or more, in this dc bias circuit, in order to improve thermal conductivity characteristics of the thin conductor line concerned while keeping the high characteristic impedance thereof, at least one relay pattern is provided on an insulator substrate on which the microstrip line is formed, and the thin conductor line is relayed through the relay pattern, in which a dimension of the relay pattern is set to be approximately several times a thickness of the thin conductor line.

### SUMMARY OF THE INVENTION

In an amplifier circuit using a transistor, it is necessary to supply power to the transistor by supplying dc power to a signal route, and a bias circuit is provided for the purpose of supplying the power to the transistor. In the case of configuring the bias circuit, when a power supply circuit for supplying the dc power to the signal route is directly connected to the bias circuit, a signal that should be originally inputted to the transistor sneaks into the bias circuit, and causes a deterioration of transmission characteristics and an oscillation phenomenon.

Moreover, as in a radio circuit, in the case where the signal route is subjected to matching at fixed characteristic impedance (50 [Ω] in a usual radio circuit), when a signal inputted from a signal line input terminal reaches a node between a signal line that forms the signal route and the bias circuit, the signal concerned is reflected to such a signal line input terminal side owing to discontinuity in impedance between the signal line and a loading unit of the bias circuit. The reflected signal thus causes the deterioration of the transmission characteristics.

Hence, in order to prevent the bias circuit from affecting the signal that transmits through the signal line, the following two points are important that,

(A) the signal does not sneak into the bias circuit, and
(B) the signal is not reflected on the node between the bias circuit and the signal line.

In order that both of the above-described (A) and (B) can be satisfied, it is necessary that, at a frequency of the signal, the bias circuit turn to an open state, that is, the impedance thereof become extremely high. In particular, with regard to (B), it is required that a voltage standing wave ratio (VSWR) as a function between the inputted signal and the reflected signal is 1.2 or less, or that a reflection gain is −20.83 [dB] or less.

Here, in a circuit as shown in FIG. 1, in which a bias circuit 3 is connected between an input line 1 and an output line 2, a specific lower limit value of the impedance, which satisfies the relationship of VSWR≦1.2, is considered. The input VSWR in the circuit shown in FIG. 1 is a function among characteristic impedance Zᵢₙ of the input line 1, characteristic impedance Zₒᵤₜ of the output line 2, and impedance Z_{b} of the bias circuit 3 connected between the input line 1 and the output line 2. The input VSWR is represented by the following Expression (1) as,

$$V S W R = \frac{1 + \frac{{Z}_{i n} - \frac{{Z}_{out} {Z}_{b}}{{Z}_{out} + {Z}_{b}}}{{Z}_{i n} + \frac{{Z}_{out} {Z}_{b}}{{Z}_{out} + {Z}_{b}}}}{1 - \frac{{Z}_{i n} - \frac{{Z}_{out} {Z}_{b}}{{Z}_{out} + {Z}_{b}}}{{Z}_{i n} + \frac{{Z}_{out} {Z}_{b}}{{Z}_{out} + {Z}_{b}}}} . \qquad ( 1 )$$

In a usual high frequency circuit, the impedance of each of the input line 1 and the output line 2 is 50 [Ω]. When a condition for the relationship of VSWR≦1.2 is calculated by assigning 50 [Ω] to Zᵢₙ and Zₒᵤₜ of Expression (1), a solution of Z_{b}≧250 [Ω] is obtained. Hence, when viewed from the input/output lines (input line 1 and output line 2) through which the signal passes, it is necessary that the impedance of the bias circuit 3 be 250 [Ω] or more.

Many bias circuits supply the power by using a coil that becomes equivalent to an open state for an ac signal and becomes equivalent to a short-circuit state for a dc. FIG. 2 is a circuit diagram showing an example of an amplifier circuit including a bias circuit that uses the coil as described above. FIG. 3 is a top view showing a structure of the amplifier circuit shown in FIG. 2. This amplifier circuit is formed on a substrate using microstrip lines, and the entire back surface of the substrate is a grounding conductor. Note that, in FIG. 3, the grounding conductor and a dc power supply device are omitted.

In the amplifier circuit shown in FIGS. 2 and 3, a field effect transistor (FET) 10 is used as an amplifier device. The FET 10 forms a common-source circuit, in which a source terminal is grounded, and a signal inputted from a gate terminal is outputted from a drain terminal. The FET is defined to be of a depression type, in which a negative voltage is applied to the gate terminal, and a positive voltage is applied to the drain terminal.

By a first signal line 11, to some midpoint of which a first dc cutting capacitor 13 is inserted, the gate terminal of the FET 10 is connected to a signal line input terminal 12 formed on an open end of the first signal line 11. The first dc cutting capacitor 13 functions to turn to the short-circuit state for the signal, and to turn to the open state for the dc. By this function, the first dc cutting capacitor 13 prevents dc power, which is supplied to the gate terminal of the FET 10 from a first gate bias circuit 14 to be described later, from leaking to the signal line input terminal 12 side.

By a second signal line 21, to some midpoint of which a second dc cutting capacitor 23 is inserted, the drain terminal of the FET 10 is connected to a signal line output terminal 22 formed on an open end of the second signal line 21. The second dc cutting capacitor 23 functions to turn to the short-circuit state for the signal, and to turn to the open state for the dc. By this function, the second dc cutting capacitor 23 prevents dc power, which is supplied to the drain terminal of the FET 10 from a first drain bias circuit 24 to be described later, from leaking to the signal line output terminal 22 side.

The first gate bias circuit 14 is connected to the first signal line 11 that joins the gate terminal of the FET 10 and the first dc cutting capacitor 13 to each other. The first gate bias circuit 14 includes a first coil 15, a first ac grounding capacitor 16, and a first dc power supply device 17. The first coil 15 is arranged between the first signal line 11 and the first dc power supply device 17. The first dc power supply device 17 generates dc power, and supplies a negative voltage to the gate terminal of the FET 10 through the first coil 15 and the first signal line 11. One end of the first ac grounding capacitor 16 is connected to a node between the first coil 15 and the first dc power supply device 17, and the other end thereof is connected through a through hole 18 to the grounding conductor on the back surface of the substrate. The first ac grounding capacitor 16 is provided for absorbing noise generated in the first dc power supply device 17 and a weak signal component that leaks from the first signal line 11 through the first coil 15.

The first drain bias circuit 24 is connected to the second signal line 21 that joins the drain terminal of the FET 10 and the second dc cutting capacitor 23 to each other. The first drain bias circuit 24 includes a second coil 25, a second ac grounding capacitor 26, and a second dc power supply device 27. The second coil 25 is arranged between the second signal line 21 and the second dc power supply device 27. The second dc power supply device 27 generates dc power, and supplies a positive voltage to the drain terminal of the FET 10 through the second coil 25 and the second signal line 21. One end of the second ac grounding capacitor 26 is connected to a node between the second coil 25 and the second dc power supply device 27, and the other end thereof is connected through a through hole 28 to the grounding conductor on the back surface of the substrate. The second ac grounding capacitor 26 is provided for absorbing noise generated in the second dc power supply device 27 and a weak signal component that leaks from the second signal line 21 through the second coil 25.

In the amplifier circuit configured as described above, when viewed from the dc power applied to each of the gate terminal and drain terminal of the FET 10, the first ac grounding capacitor 16 and the second ac grounding capacitor 26 become equivalent to the open state, and moreover, the first coil 15 and the second coil 25 become equivalent to the short-circuit state. Hence, as shown by a first dc supply route (gate bias) 32, the dc power outputted from the first dc power supply device 17 of the first gate bias circuit 14 passes through the first coil 15 while ignoring the first ac grounding capacitor 16, and is then applied to the gate terminal of the FET 10 while ignoring the first dc cutting capacitor 13. In a similar way, as shown by a second dc supply route (drain bias) 33, the dc power outputted from the second dc power supply device 27 of the first drain bias circuit 24 passes through the second coil 25 while ignoring the second ac grounding capacitor 26, and is then applied to the drain terminal of the FET 10 while ignoring the second dc cutting capacitor 23.

Moreover, each of the signal inputted to the signal line input terminal 12 and the signal outputted from the signal line output terminal 22 is an ac, and accordingly, the first dc cutting capacitor 13 and the second dc cutting capacitor 23 become equivalent to the short-circuit state. Hence, when viewed from the ac signals, the amplifier circuit shown in FIGS. 2 and 3 can be represented by an equivalent circuit shown in FIG. 4. In this equivalent circuit, each of impedance Z_{L} when the first coil 15 is viewed from the first signal line 11 and impedance Z_{L} when the second coil 25 is viewed from the second signal line 21 is a function between a frequency f₀ of the signal and inductance L of the first coil 15 or the second coil 25 (hereinafter, these are simply and generically referred to as “coils” in some case). The impedance Z_{L} is represented by the following Expression (2) as,

Z_{L}=2jπf₀L. (2)

In accordance with Expression (2), the impedance Z_{L} is increased if the inductance L or the frequency f₀ of the signal is increased. In the case where it can be regarded that the frequency f₀ of the signal is sufficiently large, and the first coil 15 and the second coil 25 are in the open state, then the signal does not flow into the first gate bias circuit 14 or the first drain bias circuit 24 (hereinafter, these are simply and generically referred to as “bias circuits” in some case). Accordingly, the above-mentioned conditions (A) and (B) can be satisfied, and the signal inputted from the signal line input terminal 12 is outputted from the signal line output terminal 22 through a signal route 31.

However, an actual coil has capacitance caused by a parasitic capacitor connected in parallel thereto as well as the inductance, and when viewed from the ac signals, the amplifier circuit shown in FIGS. 2 and 3 is represented by an equivalent circuit as shown in FIG. 5. In this equivalent circuit, each of impedance Z_{LC} when the first coil 15 is viewed from the first signal line 11 and impedance Z_{LC} when the second coil 25 is viewed from the second signal line 21 is a function among the inductance L of the first coil 15 or the second coil 25, the capacitance C of the parasitic capacitor, and the frequency f₀ of the signal. The impedance Z_{LC} is represented by the following Expression (3) as,

$$\begin{matrix}{Z}_{LC} = \frac{2 j π {f}_{0} L \cdot \frac{1}{2 j π {f}_{0} C}}{2 j π {f}_{0} L + \frac{1}{2 j π {f}_{0} C}} \\ = \frac{2 j π {f}_{0} L}{1 - 4 {π}^{2} {f}_{0}^{2} LC} \\ = \frac{2 j π {f}_{0} L}{LC \cdot ( \frac{1}{LC} - 4 {π}^{2} {f}_{0}^{2} )} .\end{matrix} \qquad ( 3 )$$

FIG. 6 shows frequency characteristics of the impedance Z_{LC} in the case where the inductance of the first coil 15 or the second coil 25 L=50 [nH], and the capacitance of the parasitic capacitor C=0.5 [pF]. Moreover, FIG. 7 shows comparison among the impedance Z_{LC}, the impedance Z_{L} in the case where only the inductance L exists and the parasitic capacitor does not exist, and the impedance Z_{c} in the case where only the parasitic capacitor exists and the inductance L does not exist. Note that, in FIG. 7, the frequencies are displayed logarithmically on a horizontal axis so that it can be easy to grasp the characteristics.

In accordance with a right most side of Expression (3), in the case where a square of the frequency f₀ of the signal is sufficiently smaller than 1/LC of an inverted product of the inductance L of the first coil 15 or the second coil 25 and the capacitance C of the parasitic capacitor, then 4n²f₀² can be ignored, and Z_{LC} becomes equal to Z_{L}. This can also be confirmed from the fact that a curve of Z_{LC} and a curve of Z_{L} substantially coincide with each other in a frequency band denoted by reference symbol α of FIG. 7. Hence, in a range where the frequency is low, the actual coil can also be regarded as an ideal coil, and accordingly, the parasitic capacitor can be ignored. Therefore, in the equivalent circuit shown in FIG. 5, the signal inputted from the signal line input terminal 12 is outputted from the signal line output terminal 22 through the signal route 31.

However, in the case where the square of the frequency f₀ of the signal is sufficiently larger than 1/LC of the inverted product of the inductance L of the first coil 15 or the second coil 25 and the capacitance C of the parasitic capacitor, then 1/LC in a denominator of Expression (3) can be replaced by 0. Accordingly, Expression (3) can be replaced by the following Expression (4) as,

$${Z}_{LC} ≅ \frac{2 j π {f}_{0} L}{LC \cdot ( 0 - 4 {π}^{2} {f}_{0}^{2} )} = - \frac{2 j π {f}_{0} L}{4 {π}^{2} {f}_{0}^{2} LC} = \frac{1}{2 j π {f}_{0} C} . \qquad ( 4 )$$

In accordance with Expression (4), in the case where the square of the frequency f₀ of the signal is sufficiently larger than 1/LC of the inverted product of the inductance L of the first coil 15 or the second coil 25 and the capacitance C of the parasitic capacitor, then in the equivalent circuit shown in FIG. 5, such an inductor portion of the first coil 15 or the second coil 25 is ignored, and the parasitic capacitors connected in parallel thereto become dominant. Hence, when viewed from the ac signals, the amplifier circuit shown in FIGS. 2 and 3 is replaced by an equivalent circuit shown in FIG. 8. This can also be confirmed from the fact that the curve of Z_{LC} and a curve of Z_{C} substantially coincide with each other in a frequency band denoted by reference symbol γ of FIG. 7. Hence, the following can be confirmed. In the case where the frequency f₀ of the signal is high, the impedance of the bias circuit decreases in inverse proportion to the frequency in accordance with Expression (4), and accordingly, VSWR is increased, the above-mentioned conditions (A) and (B) cannot be satisfied, and therefore, the bias circuit does not function satisfactorily in the frequency band where the parasitic capacitors become dominant.

Moreover, the following case is considered in accordance with Expression (3) as,

$$4 {π}^{2} {f}_{0}^{2} = \frac{1}{LC} ⇒ {f}_{0} = \frac{1}{2 π \sqrt{LC}} . \qquad ( 5 )$$

In this case, the denominator in Expression (3) becomes zero, therefore the impedance becomes infinite. This can be confirmed by the fact that the impedance is steeply increased in the vicinity of 1 [GHz] in FIGS. 6 and 7. A frequency like 1 [GHz] in FIGS. 6 and 7, that is, a frequency that becomes infinite in such a manner that the impedance is steeply increased by the inductance of the actual coil and the capacitance of the parasitic capacitor is referred to as a self-resonant frequency. The impedance is significantly increased at this self-resonant frequency, and accordingly, there also exits a method of selecting a coil so that the frequency of the signal and the self-resonant frequency can coincide with each other. However, in usual, characteristics of the self-resonant frequency are not ensured by manufactures, and variations are inherent in the self-resonant frequency concerned. Therefore, the characteristics of the bias circuit are largely affected by the variations of the self-resonant frequency. Hence, for the bias circuit, it is necessary to use a coil in which the self-resonant frequency is realized on a higher side than the frequency band of the signal.

However, in the case of realizing a bias circuit capable of supplying a large current, when the frequency of the signal is increased, it becomes difficult to realize a coil having a self-resonant frequency equal to or higher than the increased frequency. Reasons for this are as follows. In the case of flowing a large current through a coil, it is necessary to increase a conductor cross-sectional area of the coil for the purpose of reducing heat generation caused by electric resistance inherent in the coil and increasing radiation of heat thus generated, and as the cross-sectional area is being increased, parasitic capacitors generated among adjacent windings of the coil are also increased in volume. Therefore, denominator of Expression (5) is increased, causing a drop of the self-resonant frequency. As of this point in time, a coil having a current-carrying capacity of 2 [A] or more, in which a self-resonant frequency is 3 [GHz] or more, has not been realized.

Owing to a relationship between the self-resonant frequency and current-carrying capacity of the coil, it is difficult for the bias circuit using the coil to realize a circuit having a large current-carrying capacity. Therefore, for an amplifier circuit that requires a bias circuit excellent in high frequency characteristics and having a large current-carrying capacity, bias circuits have been used, in which quarter-wave lines are configured with wiring patterns formed on a substrate.

FIG. 9 is a circuit diagram showing an example of an amplifier circuit including the bias circuit as described above in which the quarter-wave lines are configured with the wiring patterns formed on the substrate. FIG. 10 is a top view showing a structure of the amplifier circuit shown in FIG. 9. This amplifier circuit is formed on a substrate using microstrip lines, and the entire back surface of the substrate is a grounding conductor. Note that, in FIG. 10, the grounding conductor and the dc power supply device are omitted.

This amplifier circuit is configured in such a manner that the first gate bias circuit 14 of the amplifier circuit shown in FIGS. 2 and 3 is replaced with a second gate bias circuit 14a, and that the first drain bias circuit 24 thereof is replaced with a second drain bias circuit 24a. In the following, a description will be mainly made of different points from those of the amplifier circuit shown in FIGS. 2 and 3.

In the second gate bias circuit 14a, a wiring pattern having characteristic impedance is used in place of the first coil 15 of the above-mentioned first gate bias circuit 14. This wiring pattern is formed toward the first dc power supply device 17 from a root of the first signal line 11 to a position where an electrical length 1 equal to quarter of the wavelength λ at a center frequency of the signal is established. Hereinafter, this wiring pattern is referred to as a first quarter-wave line 19.

In the second drain bias circuit 24a, a wiring pattern having characteristic impedance is used in place of the second coil 25 of the above-mentioned first drain bias circuit 24. This wiring pattern is formed toward the second dc power supply device 27 from a root of the second signal line 21 to a position where the electrical length 1 equal to quarter of the wavelength λ at the center frequency of the signal is established. Hereinafter, this wiring pattern is referred to as a second quarter-wave line 29.

In the amplifier circuit configured as described above, when viewed from the dc power applied to each of the gate terminal and drain terminal of the FET 10, the first ac grounding capacitor 16 and the second ac grounding capacitor 26 become equivalent to the open state, and moreover, the first quarter-wave line 19 and the second quarter-wave line 25 become equivalent to the short-circuit state. Hence, as shown by the first dc supply route (gate bias) 32, the dc power outputted from the first dc power supply device 17 of the second gate bias circuit 14a passes through the first quarter-wave line 19 while ignoring the first ac grounding capacitor 16, and is then applied to the gate terminal of the FET 10 while ignoring the first dc cutting capacitor 13. In a similar way, as shown by the second dc supply route (drain bias) 33, the dc power outputted from the second dc power supply device 27 of the second drain bias circuit 24a passes through the second quarter-wave line 29 while ignoring the second ac grounding capacitor 26, and is then applied to the drain terminal of the FET 10 while ignoring the second dc cutting capacitor 23.

Moreover, each of the signal inputted to the signal line input terminal 12 and the signal outputted from the signal line output terminal 22 is an ac, and accordingly, the first dc cutting capacitor 13 and the second dc cutting capacitor 23 become equivalent to the short-circuit state. Hence, when viewed from the ac signals, the amplifier circuit shown in FIGS. 9 and 10 can be represented by an equivalent circuit shown in FIG. 11. In this equivalent circuit, impedance when the first quarter-wave line 19 is viewed from the first signal line 11 on the gate side is defined as Z_{lg}, and impedance when the second quarter-wave line 29 is viewed from the second signal line 21 on the drain side is defined as Z_{ld}. Then, Z_{lg} and Z_{ld} are functions among the electrical length: l, the frequency of the signal: f₀, a relative permittivity: εᵣ, the characteristic impedance of the first quarter-wave line 19: Z_{0g}, and the characteristic impedance of the second quarter-wave line 29: Z_{0d}, respectively. Z_{lg} and Z_{ld} are represented by Expressions (6) and (7), respectively, as,

$$\begin{matrix}{Z}_{lg} = j {Z}_{0 g} \cdot tan ( 2 π \cdot \frac{{f}_{0}}{c} \cdot \sqrt{{ɛ}_{r}} \cdot l ) , & ( 6 ) \\ {Z}_{ld} = j {Z}_{0 d} \cdot tan ( 2 π \cdot \frac{{f}_{0}}{c} \cdot \sqrt{{ɛ}_{r}} \cdot l ) , & ( 7 )\end{matrix}$$

here, the symbol c represents a speed of light in vacuum. Moreover, the following Expression (8) is established as,

$$\frac{c}{{f}_{0}} = λ . \qquad ( 8 )$$

Here, the symbol A represents a wavelength of the signal at the frequency f₀, and the term \sqrt{εᵣ}·l represents an electrical length of the wiring pattern formed by the length l on a substrate in which a relative permittivity is εᵣ. As an example, FIG. 12 shows results of calculating Z_{lg} and Z_{ld} under conditions of: Z_{0g}=200 [Ω]; Z_{0d}=30 [Ω]; l=25 [mm]; εᵣ=9; c=2.99792458×10⁸ [m/s].

The characteristic impedance is a function between a reactance and a susceptance, which are inherent in a signal transmission line such as a wiring pattern and a coaxial line. In general, the characteristic impedance of the microstrip line is obtained by approximate expressions shown in Expression (9) by using the relative permittivity εᵣ, a substrate thickness h, and a wiring pattern width w as,

$$when \frac{w}{h} \leq l , \\ {Z}_{0} = \frac{60}{\sqrt{{ɛ}_{r}}} ln ( \frac{8 h}{w} + 0.25 \frac{w}{h} ) , \\ when \frac{w}{h} \geq l , \\ {Z}_{0} = \frac{120 π}{\sqrt{{ɛ}_{r}}} {( \frac{w}{h} + 1.393 + 0.667 ln ( \frac{h}{w} + 1.444 ) )}^{- 1} . \qquad ( 9 )$$

In accordance with Expression (9), in the case where the relative permittivity εᵣ and the substrate thickness h are constant, then the characteristic impedance is decreased as the wiring pattern width w is being increased. In accordance with Expressions (6), (7), and (8), Z_{lg} and Zₗₐ individually become infinite when \sqrt{εᵣ}·l satisfies the following Expression (10) as,

$$\sqrt{{ɛ}_{r}} \cdot l = \frac{λ}{4} \times ( 2 n - 1 ) . ( n \text{:} arbitrary integer ) \qquad ( 10 )$$

This can also be confirmed by the fact that the impedance is steeply increased in the vicinity of 1 [GHz] in FIG. 12. As a result, when \sqrt{εᵣ}·l becomes a length of λ/4 (quarter-wavelength), the first quarter-wave line 19 and the second quarter-wave line 29 become equivalent to the open state, and satisfy the above-mentioned conditions (A) and (B). This represents that, in the amplifier circuit shown in FIGS. 9 and 10, the signal inputted to the signal line input terminal 12 is outputted from the signal line output terminal 22 through the signal route 31, and indicates that the bias circuit can be realized by setting the wiring pattern length at λ/4 (quarter-wavelength) with respect to the signal frequency.

Moreover, in accordance with Expressions (6) and (7), it can also be confirmed that Z_{lg} and Z_{ld} are proportional to Z_{0g} and Z_{0d}. This indicates that Z_{lg} and Z_{ld} can realize high impedance in a wide frequency band in the case where Z_{0g} and Z_{0d} are large, in other words, in the case where a width of the first quarter-wave line 19 or the second quarter-wave line 29 is narrow. This can also be confirmed from the following fact. In FIG. 12, while the impedance is decreased as the frequency is being apart from 1 [GHz], a gradient of the impedance Z_{lg} becomes more gentle than that of the impedance Z_{ld} as the frequency is being apart from 1 [GHz]. In Z_{ld}, a frequency range where the impedance becomes 250 [Ω] or more at which VSWR≦1.2 is realized in the 50 [Ω] series is approximately 0.9 to 1.1 [GHz]. As opposed to this, in Z_{lg}, such a frequency range is as wide as approximately 0.75 to 1.25 [GHz].

Though an electron tube was used for a high-frequency and high-output amplifier in the past, a transistor has been being used in place of the electron tube. In order to operate a high-output transistor, it is necessary to also increase dc power to be supplied thereto. Therefore, it is necessary to also use a bias circuit in which a current-carrying capacity is large in order to make it possible to supply high power.

In the case of using the bias circuit having the quarter-wave lines, in order to increase the current-carrying capacity, it is necessary to widen the width of the lines, or to increase the thickness of the conductor configuring the lines. This is because the current-carrying capacity of the wiring pattern is proportional to the thickness of the wiring pattern, the width of the wiring pattern, and conductivity inherent in a material of the wiring pattern. In usual, a current limit of the wiring pattern conforms to MIL-STD-275D of the MIL Standard.

However, as the frequency is being increased, the characteristics become prone to be affected by accuracy of the wiring pattern. Accordingly, an increase of the conductor thickness, which leads to a decrease of the accuracy of the wiring pattern, must be avoided. Hence, in general, the current-carrying capacity is increased by increasing the width of the wiring pattern. However, when the width of the quarter-wave lines is widened, the impedance at the frequencies apart from the center frequency of the signal is decreased in terms of the gradient, and accordingly, the frequency range in which VSWR≦1.2 is established is narrowed. As a result, in the case of an amplifier using a wide frequency band, it is difficult for the bias circuits in which the quarter-wave lines are configured with the wiring patterns formed on the substrate to increase the current-carrying capacity.

As a communication using the high-frequency and high-output amplifier, a communication for use in transmission by satellite, which is called Satellite News Gathering (SNG), or the like is known. In the SNG, a frequency bans as high as 13.75 to 14.5 [GHz] is used, an output as high as 100 [W] or more is required, and the amplifier is configured by synthesizing transistors. For the amplifier for use in the SNG, a transistor of 50 [W] class can be used, and it is necessary to supply dc power of 5 [A] or more in order to obtain the maximum output.

A frequency of a signal treated by the amplifier for use in the SNG is high, and accordingly, a loss of the signal is increased by a substrate that configures the amplifier circuit. In order to suppress the loss of the signal, which is caused by the substrate, it is necessary to thin a thickness of the substrate, and to use a base material in which a permittivity and a dissipation factor are low. Moreover, it is also required that the accuracy of each wiring pattern be approximately 50 [μm], and accordingly, it is desirable that a thickness of copper that forms the wiring pattern is 50 [μm]. Hence, it is conceived to be common that a substrate is used, which is made of Teflon (registered trademark) in which the relative permittivity and the dissipation factor are low, wherein the substrate thickness is 0.508 [mm], and the conductor thickness is 35 [μm].

Moreover, the permittivity of the substrate, the substrate thickness and the dimension of the wiring pattern have manufacturing variations, and are varied also by a temperature, environmental conditions, and the like. The variations of the permittivity of the substrate, the substrate thickness and the dimension of the wiring pattern affect frequency characteristics of the circuit. Therefore, it is necessary to provide a wider margin to a frequency range required for the circuit than to the frequency range for use in the communication.

Under the above-described conditions, when the width of the wiring pattern in which such an allowable current conforming to MIL-STD-275D becomes 5 [A] or more is calculated, a width of 3 [mm] is obtained. FIG. 13 shows reflection characteristics in the event where the second quarter-wave line 29 is realized by the wiring pattern with a width of 3 [mm] in the second drain bias circuit 24a of the bias circuit shown in FIGS. 9 and 10. Note that, as a component for grounding the second quarter-wave line 29, an open circuit stab may be used in place of the second ac grounding capacitor 26.

As shown in FIG. 13, the frequency range, in which VSWR is 1.2 or less, that is, the reflection gain is −20.83 [dB] or less, is 13.748 to 14.511 [GHz]. Hence, in the case of realizing the bias circuit for use in the high-frequency and high-output amplifier used in the SNG, it is difficult to absorb variations of the frequency characteristics of the circuit, which are caused by the variations of the permittivity of the substrate, the substrate thickness, and the dimension of the wiring pattern.

It is an object of the present invention to provide a bias circuit capable of obtaining better frequency characteristics than the bias circuit in which the quarter-wave lines are configured with the wiring pattern formed on the substrate.

In order to achieve the above-described object, a first aspect of the present invention is a bias circuit that is provided in a circuit including an input line and an output line, and is formed on a substrate supplying dc power to an active component, the input line reaching an input terminal of the active component from a signal line input terminal to which a signal is inputted, and the output line reaching, from an output terminal of the active component, a signal line output terminal outputting a signal therefrom, the bias circuit including: a power supply line supplied with the dc power; a bridge-like metal structure subjected to a bending process, the metal structure connecting the output line and the power supply line to each other; and a capacitive component provided between a ground and a node between the power supply line and the metal structure.

In accordance with the first aspect of the present invention, the bridge-like metal structure subjected to the bending process is used for connecting the output line and the power supply line to each other. Accordingly, a bias circuit having a larger current-carrying capacity and excellent in reflection characteristics in a wider band than the bias circuit in which the quarter-wave line is configured with the wiring pattern formed on the substrate can be realized, and a bias circuit capable of obtaining satisfactory frequency characteristics can be provided.

### BRIEF DESCRIPTION OF THE DRAWINGS

FIG. 1 is a view showing a general configuration of a circuit including a bias circuit connected between an input line and an output line.

FIG. 2 is a circuit diagram showing an example of an amplifier circuit including bias circuits using coils.

FIG. 3 is a top view showing a structure of the amplifier circuit shown in FIG. 2.

FIG. 4 is a view showing an equivalent circuit viewed from ac signals of the amplifier circuit shown in FIGS. 2 and 3.

FIG. 5 is a view showing an actual equivalent circuit viewed from the ac signals in a case of considering capacitance of each of the coils in the amplifier circuit shown in FIGS. 2 and 3.

FIG. 6 is a graph showing a frequency characteristic of impedance in a case where inductance of each of the coils and capacitance of each of parasitic capacitors exist in the amplifier circuit shown in FIGS. 2 and 3.

FIG. 7 is a graph showing comparison in frequency characteristics of the impedance among, in the amplifier circuit shown in FIGS. 2 and 3, a case where inductance of the coil exists, a case where the capacitance of the parasitic capacitor exists, and a case where both of the inductance and the capacitance exist.

FIG. 8 is a view showing an actual equivalent circuit viewed from the ac signals in a case where a frequency is high in the amplifier circuit shown in FIGS. 2 and 3.

FIG. 9 is a circuit diagram showing an example of an amplifier circuit including bias circuits in which quarter-wave lines are configured with wiring patterns formed on a substrate.

FIG. 10 is a top view showing a structure of the amplifier circuit shown in FIG. 9.

FIG. 11 is a view showing an equivalent circuit viewed from ac signals of the amplifier circuit shown in FIGS. 9 and 10.

FIG. 12 is a graph showing an example of frequency characteristics of impedance of the amplifier circuit shown in FIGS. 9 and 10.

FIG. 13 is a graph showing an example of a reflection characteristic of a bias circuit shown in FIGS. 9 and 10, in which a quarter-wave line is configured with a wiring pattern formed on a substrate.

FIG. 14 is a circuit diagram showing an example of an amplifier circuit including a bias circuit according to an embodiment of the present invention.

FIG. 15 is a top view showing a structure of the amplifier circuit shown in FIG. 14.

FIG. 16 is a cross-sectional view showing the amplifier circuit shown in FIG. 15, which is cut along a line X-X′.

FIG. 17 is a view showing comparison between an example of a reflection characteristic of the bias circuit according to the embodiment of the present invention and an example of the reflection characteristic of the bias circuit in which the quarter-wave line is configured with the wiring pattern formed on the substrate as shown in FIG. 13.

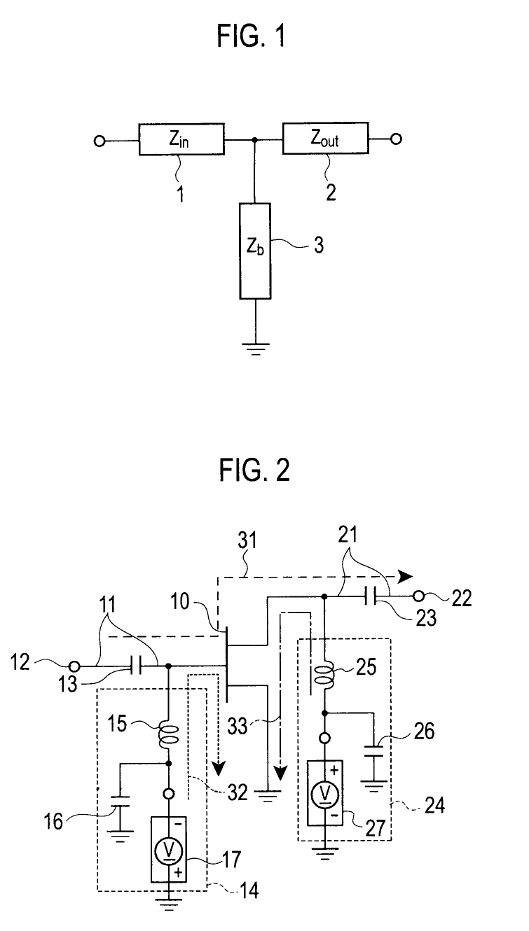

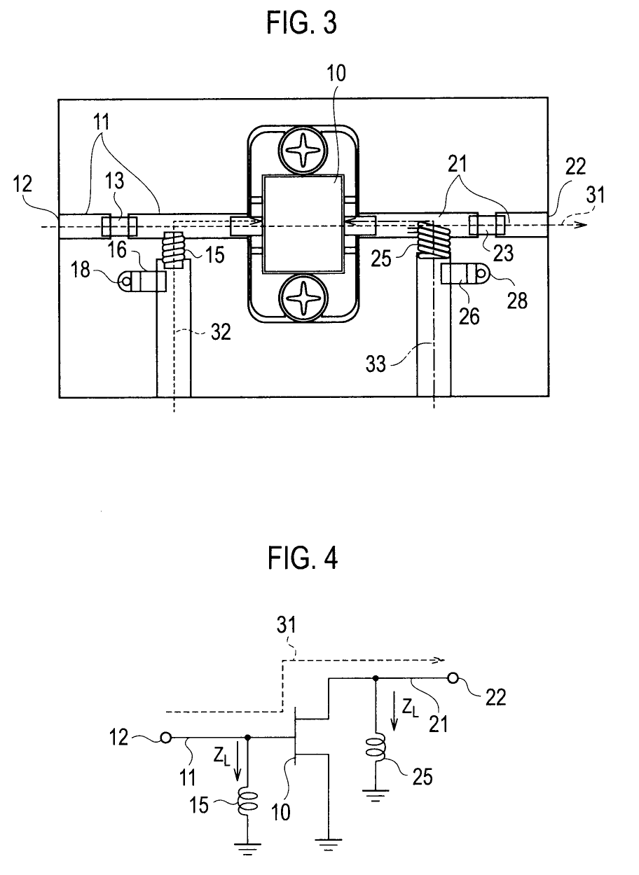

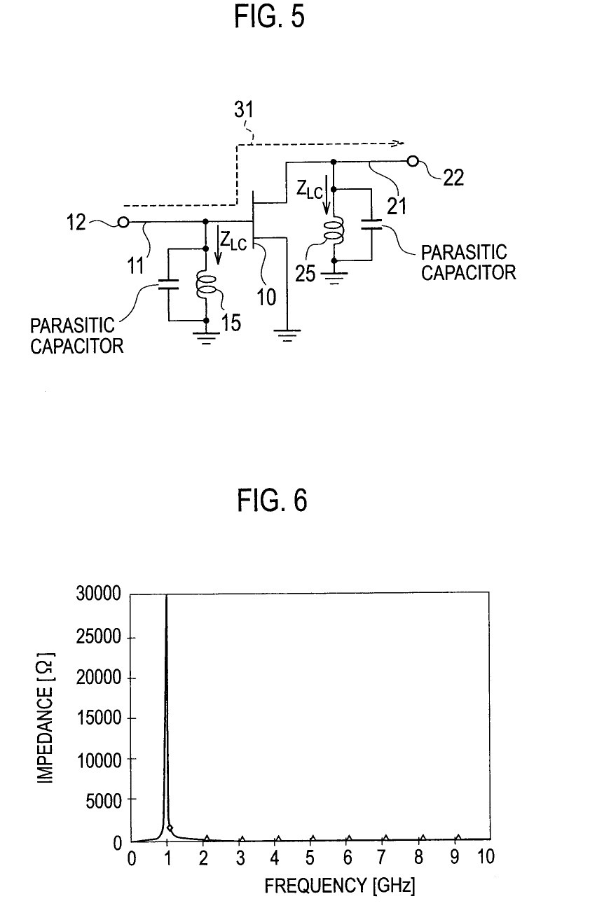

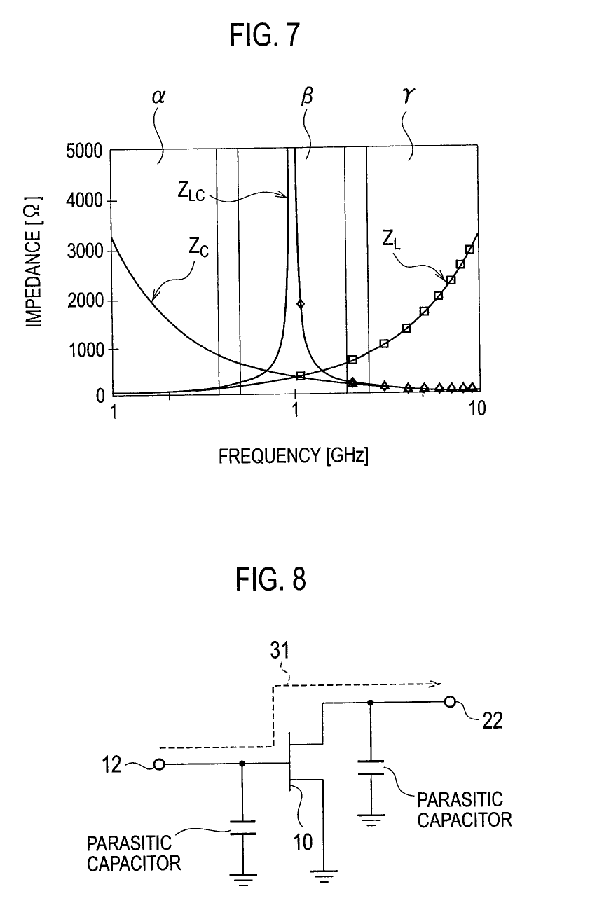

### DESCRIPTION OF THE EMBODIMENT

A description will be made below in detail of an embodiment of the present invention while referring to the drawings.

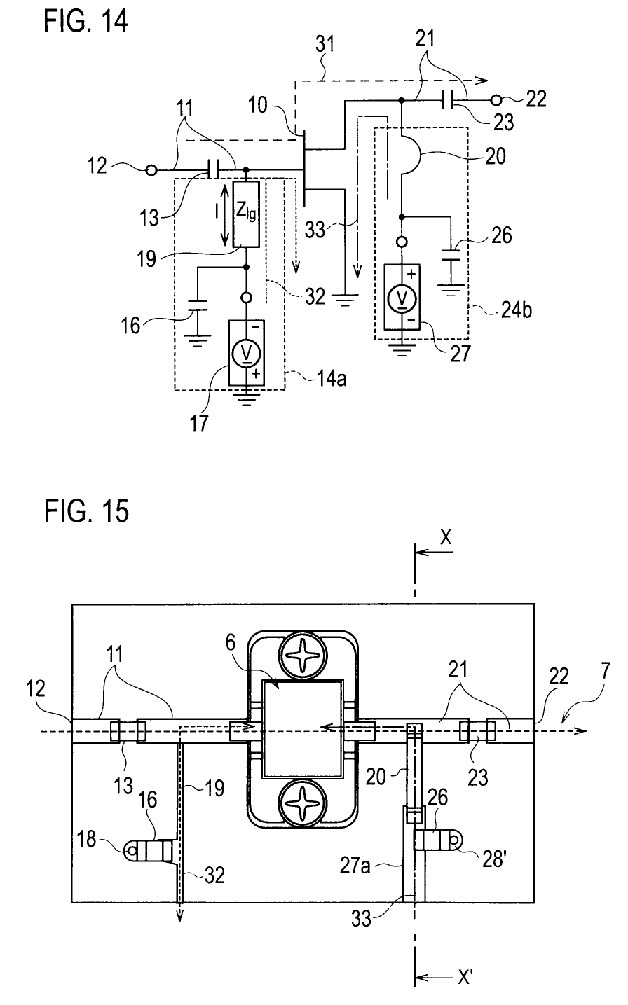

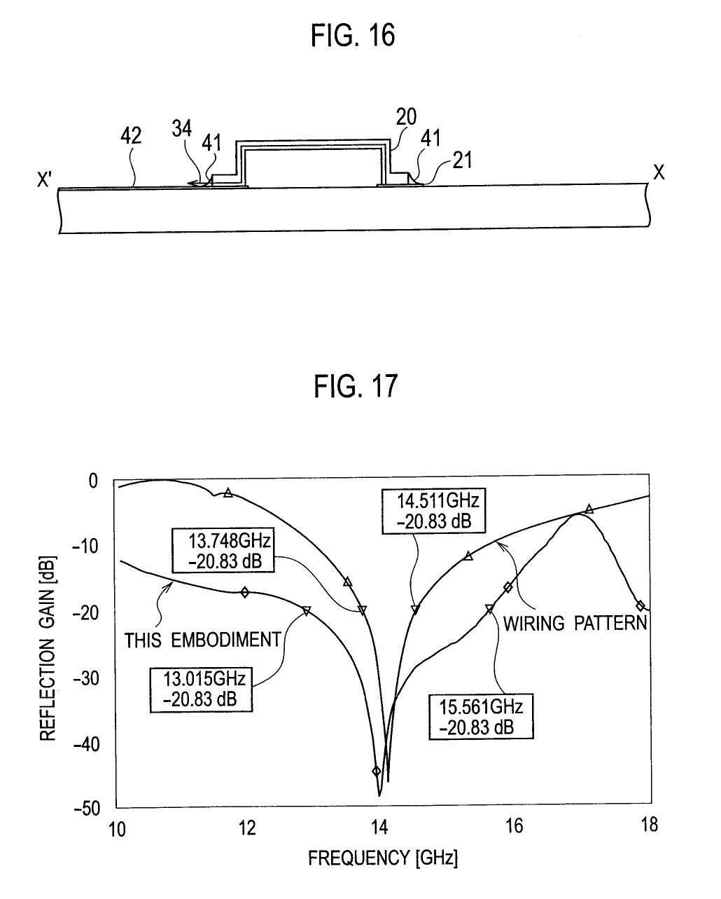

FIG. 14 is a circuit diagram showing an example of an amplifier circuit including a bias circuit according to the embodiment of the present invention. FIG. 15 is a top view showing a structure of the amplifier circuit shown in FIG. 14. This amplifier circuit is formed on a substrate using microstrip lines, and the entire back surface of the substrate is a grounding conductor. Note that, in FIG. 15, the grounding conductor and a dc power supply device are omitted. Moreover, FIG. 16 is a cross-sectional view showing the amplifier circuit shown in FIG. 15, which is cut along a line X-X′.

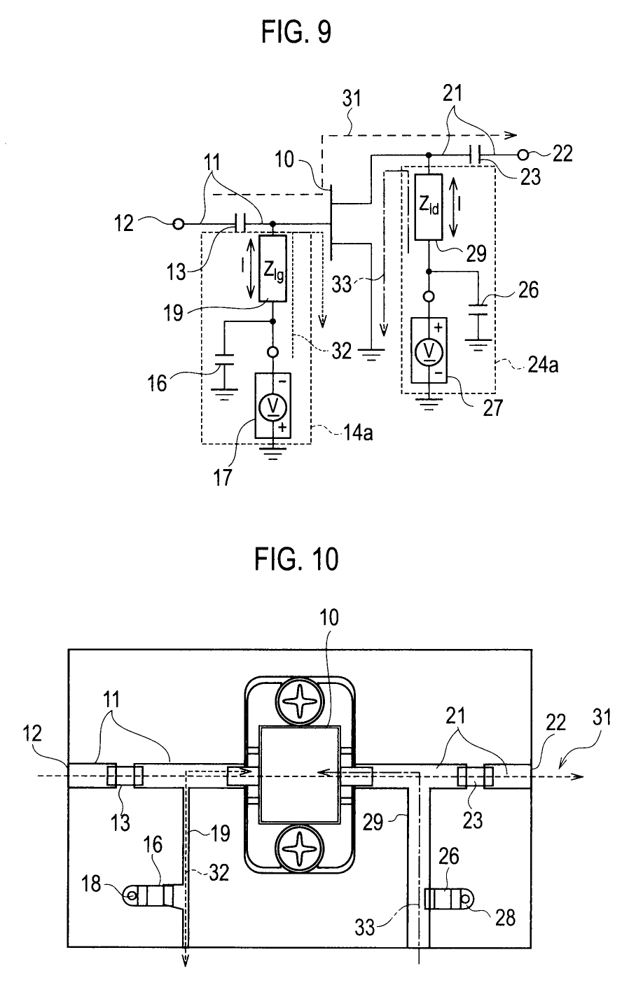

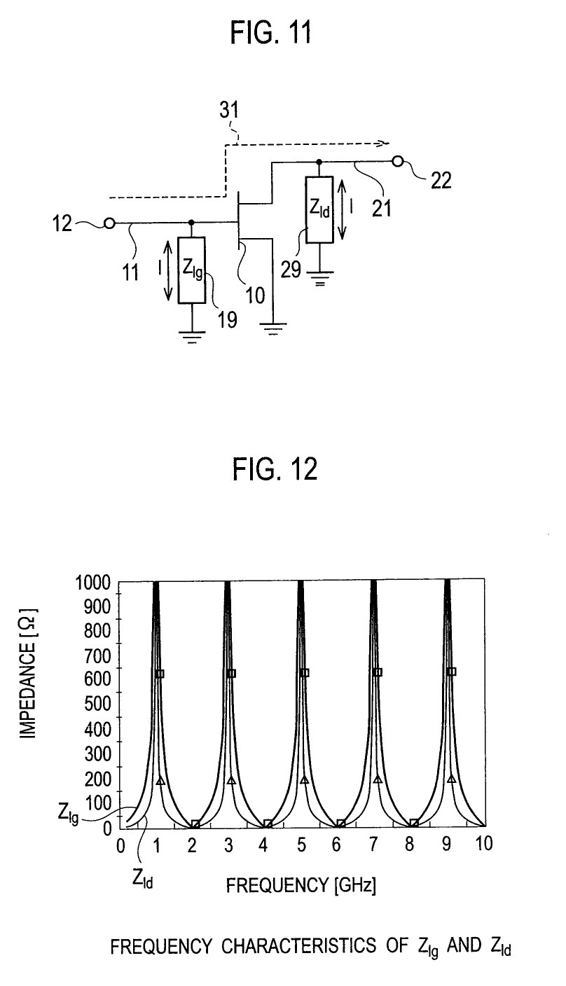

This amplifier circuit is configured in such a manner that the second drain bias circuit 24a of the amplifier circuit shown in FIGS. 9 and 10 is changed to a third drain bias circuit 24b. In the following, the description will be made of the embodiment while assigning the same reference numerals as the reference numerals used in FIGS. 9 and 10 to the same or equivalent constituents as those of the amplifier circuit shown in FIGS. 9 and 10.

In this amplifier circuit, an FET (active component) is used as an amplifier device. The FET 10 forms a common-source circuit, in which a source terminal is grounded, and a signal inputted from a gate terminal (input terminal of the active component) is outputted from a drain terminal (output terminal of the active component). The FET is defined to be of the depression-type, in which a negative voltage is applied to the gate terminal, and a positive voltage is applied to the drain terminal.

By a first signal line (input line) 11, to some midpoint of which a first dc cutting capacitor 13 is inserted, the gate terminal of the FET 10 is connected to a signal line input terminal 12 formed on an open end of the first signal line 11. The first dc cutting capacitor 13 functions to turn to the short-circuit state for the signal, but to turn to the open state for the dc. By this function, the first dc cutting capacitor 13 prevents dc power, which is supplied to the gate terminal of the FET 10 from a second gate bias circuit 14a to be described later, from leaking to the signal line input terminal 12 side.

By a second signal line (output line) 21, to some midpoint of which a second dc cutting capacitor 23 is inserted, the drain terminal of the FET 10 is connected to a signal line output terminal 22 formed on an open end of the second signal line 21. The second dc cutting capacitor 23 functions to turn to the short-circuit state for the signal, but to turn to the open state for the dc. By this function, the second dc cutting capacitor 23 prevents dc power, which is supplied to the drain terminal of the FET 10 from the third drain bias circuit 24b to be described later, from leaking to the signal line output terminal 22 side.

The second gate bias circuit 14a is connected to the first signal line 11 that joins the gate terminal of the FET 10 and the first dc cutting capacitor 13 to each other. The second gate bias circuit 14a is configured with a first quarter-wave line 19 having characteristic impedance, a first ac grounding capacitor 16 and a first dc power supply device 17.

The first quarter-wave line 19 is configured with a wiring pattern extended toward the first dc power supply device 17 from a root of the first signal line 11 to a position where an electrical length 1 equal to quarter of a wavelength λ at a center frequency of the signal is established. The first dc power supply device 17 generates dc power, and supplies a negative voltage to the gate terminal of the FET 10 through the first quarter-wave line 19 and the first signal line 11. One end of the first ac grounding capacitor 16 is connected to a node between the first λ/4 line 19 and the first direct current power supply device 17, and the other end thereof is connected through a through hole 18 to the grounding conductor on the back surface of the substrate. The first ac grounding capacitor 16 is provided for absorbing noise generated in the first dc power supply device 17 and a weak signal component that leaks from the first signal line 11 through the first quarter-wave line 19.

The third drain bias circuit 24b is connected to the second signal line 21 that joins the drain terminal of the FET 10 and the second dc cutting capacitor 23 to each other. The third drain bias circuit 24b includes a surface-mounted jumper 20, a second ac grounding capacitor (capacitive component) 26, and a second dc power supply device 27.

The surface-mounted jumper 20 is arranged so that a portion thereof between the second signal line 21 and a tip end of a power supply line 27a formed of a wiring pattern extended from the second dc power supply device 27, that is, a portion thereof between a root of the second signal line 21 and the tip end of the power supply line 27 can have the electrical length equal to quarter of the wavelength 2\ at the center frequency of the signal. As shown in FIG. 16, the surface-mounted jumper 20 is configured with a bridge-like metal structure subjected to a bending process. A pad formed on one end of the surface-mounted jumper 20 is bonded to a substantial center of the second signal line 21 by a conductive bonding material, for example, solder 41, and a pad formed on the other end thereof is bonded to a tip end of a wiring pattern 42 by solder 41. With this configuration, the surface-mounted jumper 20 is fixed to be spaced from the substrate so that a portion thereof between the pads cannot be brought into contact with the substrate. Note that, preferably, a surface (pad) of the surface-mounted jumper 20, which is connected to the second signal line 21, is constructed to be smaller than a line width of the second signal line 21.

The second dc power supply device 27 generates dc power, and supplies a positive voltage to the drain terminal of the FET 10 through the surface-mounted jumper 20 and the second signal line 21. One end of the second ac grounding capacitor (capacitive component) 26 is connected to a node between the surface-mounted jumper 20 and the second dc power supply device 27, and the other end thereof is connected through a through hole 28 to the grounding conductor on the back surface of the substrate. The second ac grounding capacitor 26 is provided for absorbing noise generated in the second dc power supply device 27 and a weak signal component that leaks from the second signal line 21 through the surface-mounted jumper 20.

In the case of realizing the quarter-wave line by using the surface-mounted jumper 20 as shown in FIG. 16, the surface-mounted jumper 20 is equivalent to a microstrip line in which air is sandwiched between a substrate and a line. A relative permittivity of the air is the minimum, and the surface-mounted jumper line 20 is fixed to be spaced from the substrate, and is thereby located far from a ground plane. Accordingly, the relative permittivity εᵣ is reduced, the substrate thickness h is increased, and as understandable from Expression (9), the characteristic impedance Zₒ is increased.

Hence, when the quarter-wave line realized by the wiring pattern on the substrate and the quarter-wave line realized by the surface-mounted jumper 20 are compared with each other, it is understood that the characteristic impedance of the quarter-wave line formed of the surface-mounted jumper 20 is larger in the case where wiring widths thereof are equal to each other. Moreover, a current of a high-frequency signal does not flow through the center of the signal line, but mostly flows through outer of the signal line. Therefore, rather than in the case where the quarter-wave line is configured by connecting the wiring pattern to the end of the signal line as shown in FIGS. 9 and 10, the bias circuit according to this embodiment, which is connected to the center portion of the signal line, can reduce the influence given to the signal current, and can suppress the reflection of the signal on the node between the signal line and the bias circuit.

Moreover, the surface-mounted jumper 20 is the metal structure that can be easily manufactured from a sheet metal or the like, and also has a thickness of nearly 100 times that of the wiring pattern realized on the substrate, and accordingly, is capable of significantly increasing the current-carrying capacity proportional to the width and thickness of the wiring.

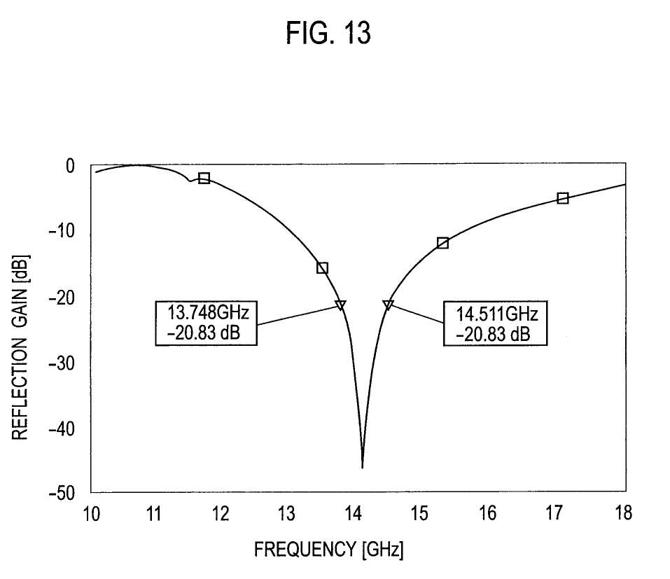

As described above, in accordance with the amplifier circuit using the bias circuit according to the embodiment of the present invention, the following effects are obtained. FIG. 17 is a view showing comparison between examples of reflection characteristic of the bias circuit for use in the amplifier for the SNG in the case of this embodiment where the quarter-wave line is configured by using a commercially available general-purpose surface-mounted jumper (MJ-0.2 made by Mac-Eight Co., Ltd) and in the case of wiring pattern where the quarter-wave line is configured with the wiring pattern formed on the substrate as shown in FIG. 13. Note that, in this embodiment, as the capacitive component for grounding the quarter-wave line, an open circuit stab can be used in place of the second ac grounding capacitor 26. Therefore, the reflection characteristic of this embodiment, which is shown in FIG. 17, represents the case of using the open circuit stab.

As shown in FIG. 17, in a wider band than in the bias circuit in which the quarter-wave line is configured by using the wiring pattern formed on the substrate, the bias circuit of this embodiment achieves the reflection gain of −20.83 [dB] or less, in which the relationship of VSWR≦1.2 is established. Specifically, in the bias circuit according to this embodiment, a frequency range in which the reflection gain of −20.83 [dB] or less is achieved is 13.015 to 15.561 [GHz], and it can be confirmed that the bias circuit according to this embodiment is an effective bias circuit in a sufficiently wider band than the frequency range of 13.75 to 14.5 [GHz] for use in the SNG. Hence, in accordance with the bias circuit according to this embodiment, it becomes possible to absorb the variations of the frequency characteristics, which are caused by the variations of the permittivity, the substrate thickness, and the dimension of the wiring pattern, while the bias circuit in which the quarter-wave line is configured with the wiring pattern formed on the substrate has difficulty absorbing the variations concerned of the frequency characteristics.

Moreover, also with regard to the current-carrying capacity, the MJ-0.2 made by Mac-Eight Co., Ltd. has a wiring width w of 0.8 [mm] and a conductor thickness t of 0.5 [mm], and consequently has a larger cross-sectional area than the quarter-wave line realized at a pattern width of 3 [mm] and a conductor thickness of 35 [μm] on the substrate in which the current-carrying capacity is 5 [A]. In addition, for the MJ-0.2, a current-carrying capacity of 7 [A] is ensured by the manufacturer.

As described above, in accordance with the embodiment of the present invention, a bias circuit having a larger current-carrying capacity and excellent in reflection characteristics in a wider band than the bias circuit in which the quarter-wave line is configured with the wiring pattern formed on the substrate can be realized. By using the bias circuit according to the embodiment of the present invention, an amplifier required to be high-frequency and high-output in the SNG and the like becomes realizable.

What is claimed is:

1. A bias circuit that is provided in a circuit including an input line and an output line, and is formed on a substrate supplying dc power to an active component, the input line reaching an input terminal of the active component from a signal line input terminal to which a signal is inputted, and the output line reaching, from an output terminal of the active component, a signal line output terminal outputting a signal therefrom, the bias circuit comprising:
a power supply line supplied with the dc power;
a bridge-like metal structure subjected to a bending process, the metal structure connecting the output line and the power supply line to each other; and
a capacitive component provided between a ground and a node between the power supply line and the metal structure.

2. The bias circuit of claim 1, wherein a surface of the metal structure, the surface being connected to the output line, is smaller than a line width of the output line.

3. The bias circuit of claim 1, wherein the metal structure is a surface-mounted jumper.

4. The bias circuit of claim 1, wherein the capacitive component is a capacitor.

5. The bias circuit of claim 1, wherein the capacitive component is an open circuit stab.
